(19) United States
(12) Patent Application Publication
(10) Pub. No.: US 2026/0356519 A1
(43) Pub. Date: Nov. 12, 2026

(54) AUTOMATIC SIDE-OPENING DRONE HANGAR AND CONTROL METHOD

(71) Applicant: Hollyway Group Pte. Ltd., Singapore (SG)

(72) Inventor: Larry LEE, Singapore (SG)

(21) Appl. No.: 19/200,656

(22) Filed: May 6, 2025

(51) Int. Cl. B64U 80/70; E05F 15/638; E05F 15/649

(52) U.S. Cl. CPC B64U 80/70; E05F 15/638; E05F 15/649; E05Y 2201/41; E05Y 2201/422; E05Y 2201/604; E05Y 2201/624; E05Y 2201/71; E05Y 2400/30; E05Y 2400/354; E05Y 2800/266; E05Y 2900/108

(57) ABSTRACT

The application discloses an automatic side-opening drone hangar and control method. The system includes a hangar body with a door, a rotating assembly, a swing arm assembly, and a driving assembly. The swing arm assembly features a first swing arm, with one end connected to the hangar door and the other to the rotating assembly. The driving assembly, mounted on the hangar's inner wall, is linked to the rotating assembly and drives it to rotate the swing arm. This movement causes the hangar door to rotate along the outer wall of the hangar body, enabling automatic opening and closing. The design allows the hangar door to move efficiently along the hangar's exterior, minimizing the space required for door operation and improving deployment efficiency.

### TECHNICAL FIELD

The present application relates to the technical field of drone hangars, and in particular to an automatic side-opening drone hangar and a control method thereof.

### BACKGROUND

With the rapid development of drone technology, the application of drones in various fields such as logistics, agriculture, aerial photography, and rescue is becoming increasingly widespread. Drone hangars serve as an important storage and maintenance facility for drones, and the design and management level of drone hangars directly affect the efficiency and safety of drone usage.

However, in the prior art, a hangar door is usually mounted at the top of the drone hangar to enable drone flight. However, in adverse weather conditions, such as rain and snow, rain and snow can fall into the hangar through the top-mounted hangar door, causing short circuits in wiring of the drone, which can severely result in damage to the drone. Additionally, in the prior art, when the top-mounted hangar door automatically opens, the mechanical structure that allows the door to open may experience jamming due to long-term use or component aging, which leads to weakened stability when the hangar door opens. When the drone takes off, the weak stability of the hangar door may obstruct the flight of the drone. Furthermore, some drone hangars use sliding door designs, which require a large amount of space either inside or outside the hangar when opening. In scenarios with densely arranged hangars or limited space, this design leads to wasted space and can even affect the normal use of adjacent hangars.

### SUMMARY

In order to solve the above technical problems, the present application is proposed. The embodiments of the present application provide an automatic side-opening drone hangar and control method, which solve the problems in the prior art of the hangar door of a drone hangar causing damage to internal components, getting stuck when opening, having weak stability during opening, and occupying a large amount of space.

According to one aspect of the present application, an automatic side-opening drone hangar is provided, comprising:

A hangar body, the hangar body comprising a hangar door;

A rotating assembly, the rotating assembly fixedly connected to the inner wall of the hangar body;

A swing arm assembly, the swing arm assembly comprising a first swing arm, a first end of the first swing arm fixedly connected to the hangar door, and a second end of the first swing arm fixedly connected to the rotating assembly;

A driving assembly, the driving assembly fixedly connected to the inner wall of the hangar body, and the driving assembly transmission-connected to the rotating assembly; the driving assembly is used for driving the rotating assembly to cause the first swing arm to rotate around the axis of the rotating assembly, causing the first swing arm to cause the hangar door to rotate around the outer wall of the hangar body.

In one embodiment, the rotating assembly comprises: a rotating shaft, a first bearing, a first bearing seat, and a transmission component; the first bearing is sleeved on a first end of the rotating shaft, the first bearing seat is fixedly connected to the bottom of the accommodating space of the hangar body, a second end of the first swing arm is fixedly connected to the rotating shaft, the first bearing seat is used for fixing the first bearing, the transmission component is sleeved on the rotating shaft, the transmission component is transmission-connected to the driving assembly, and the driving assembly is used for driving the transmission component to cause the rotating shaft to rotate around the axis of the first bearing.

In one embodiment, the rotating assembly comprises: a second bearing and a second bearing seat; the second bearing is sleeved on a second end of the rotating shaft, the second bearing seat is fixed on the inner wall of the hangar body, and the second bearing seat is used for fixing the second bearing.

In one embodiment, the first swing arm comprises: a first bent part and a first straight part; one end of the first bent part is fixedly connected to one end of the first straight part, another end of the first bent part is fixedly connected to the rotating shaft, another end of the first straight part is fixedly connected to the inner wall of the hangar door, and the first bent part is used for limiting the rotation of the hangar door around the outer wall of the hangar body.

In one embodiment, the swing arm assembly comprises a second swing arm; a first end of the second swing arm is movably connected to the top of the accommodating space of the hangar body, and a second end of the second swing arm is fixedly connected to the inner wall of the hangar door.

In one embodiment, the second swing arm comprises a second bent part and a second straight part; a first end of the second bent part is fixedly connected to a first end of the second straight part, a second end of the second bent part is fixedly connected to the inner wall of the hangar door, and a second end of the second straight part is movably connected to the top of the accommodating space of the hangar body; wherein, the second bent part is used for limiting the rotation of the hangar door around the outer wall of the hangar body.

In one embodiment, the hangar body comprises a hangar frame; the hangar frame comprises a first base plate, a second base plate, and a first curved component; a top edge of the first base plate is fixedly connected to the bottom of the first curved component, the bottom edge of the second base plate is fixedly connected to the top of the first curved component, and the hangar frame and the hangar door form a cylinder or an elliptical cylinder.

In one embodiment, the automatic side-opening drone hangar further comprises a door-opening sensor and a controller; the door-opening sensor is communicatively connected to the controller, the door-opening sensor is fixed at the bottom of the accommodating space of the hangar body, the controller is communicatively connected to the driving assembly, the door-opening sensor is used for sending a first trigger signal to the controller, and the first controller is used for generating a first stop command to stop the operation of the driving assembly.

In one embodiment, the hangar body comprises a door frame matching the hangar door; the edge of the door frame is fixedly connected to a sealing strip; wherein, the door frame is formed by the edge of the hangar frame that forms a semi-open space.

According to another aspect of the present application, a control method for an automatic side-opening drone hangar is provided, characterized in that, it is adapted to the automatic side-opening drone hangar described in any of the preceding claims, wherein the control method comprises:

Receiving an opening command; wherein, the opening command is a command to open the hangar door;

Executing the opening command and controlling the driving assembly to drive the rotating assembly to cause the first swing arm to rotate around the axis of the rotating assembly, to cause the first swing arm to cause the hangar door to rotate around the outer wall of the hangar body; Stopping the operation of the driving assembly when the hangar door reaches a target position. The automatic side-opening drone hangar and control method provided by the present application comprises: a hangar body, a rotating assembly, a swing arm assembly, and a driving assembly. The hangar body comprises a hangar door. The rotating assembly is fixedly connected to the inner wall of the hangar body. The swing arm assembly comprises a first swing arm. A first end of the first swing arm is fixedly connected to the hangar door. A second end of the first swing arm is fixedly connected to the rotating assembly. The driving assembly is fixedly connected to the inner wall of the hangar body. The driving assembly is transmission-connected with the rotating assembly. The driving assembly is used for driving the rotating assembly to cause the first swing arm to rotate around the axis of the rotating assembly, to cause the first swing arm to cause the hangar door to rotate around the outer wall of the hangar body. The driving assembly drives the rotating assembly to cause the first swing arm to rotate around the axis of the rotating assembly, therefore the first swing arm causes the hangar door to rotate around the outer wall of the hangar body to achieve opening and closing of the drone hangar. In addition, since the hangar door rotates around the outer wall of the hangar body, the space occupied by the hangar door is also reduced. The present application adopts a side-opening design, which can better protect electrical equipment inside the hangar, the drone, and other components. Additionally, by fixing the first swing arm on the transmission component and having the first swing arm rotate within a certain spatial area inside the hangar, the support for the hangar door is enhanced, and the stability of rotation of the hangar door is improved. Furthermore, when the drone takes off, the side-opening design will not obstruct the flight of the drone.

### BRIEF DESCRIPTION OF THE DRAWINGS

Through more detailed descriptions of the embodiments of the present application in conjunction with the accompanying drawings, the above descriptions and other objectives, features, and advantages of the present application will become more apparent. The accompanying drawings are used for providing further understanding of the embodiments of the present application and form a part of the specification. They are used together with the embodiments of the present application to explain the present application and do not constitute a limitation on the present application. In the drawings, the same reference numerals generally represent the same components or steps.

FIG. 1 is a schematic structural diagram of an automatic side-opening drone hangar provided by an exemplary embodiment of the present application.

FIG. 2 is a schematic structural diagram of the automatic side-opening drone hangar provided by another exemplary embodiment of the present application.

FIG. 3 is a schematic structural diagram of a transmission device and a driving device provided by an exemplary embodiment of the present application.

FIG. 4 is a side view schematic diagram of the automatic side-opening drone hangar provided by an exemplary embodiment of the present application.

FIG. 5 is an enlarged view “A” of a schematic diagram of the automatic side-opening drone hangar provided by an exemplary embodiment of the present application.

FIG. 6 is a structural diagram of an electronic device provided by an exemplary embodiment of the present application.

Reference numerals in the drawings: 11, hangar body; 12, rotating assembly; 13, swing arm assembly; 14, driving assembly; 111, hangar door; 131, first swing arm; 12, rotating assembly; 121, rotating shaft; 122, first bearing; 123, first bearing seat; 124, transmission component; 125, second bearing; 126, second bearing seat; 1311, first bent part; 1312, first straight part; 13121, first straight rod; 13122, second straight rod; 13123, third straight rod; 13111, first bent rod; 13112, second bent rod; 132, second swing arm; 1321, second bent part; 1322, second straight part; 133, third swing arm; 1331, third bent part; 1332, third straight part; 15, door-opening sensor; 127, contact plate; 16, door-closing sensor; 112, sealing strip; 141, motor; 142, gear; 1000, electronic device; 1100, processor; 1200, memory; 1300, input device; 1400, output device.

### DETAILED DESCRIPTION OF EMBODIMENTS

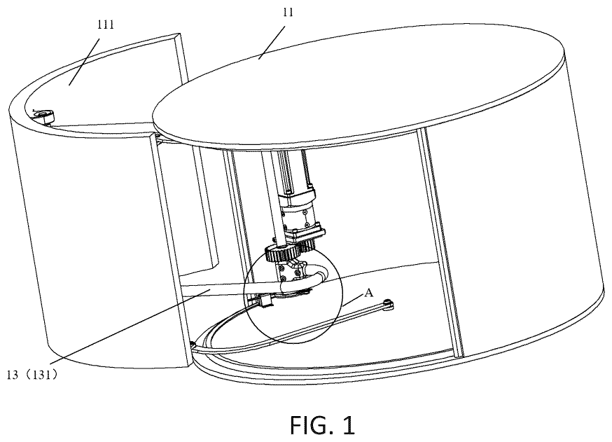

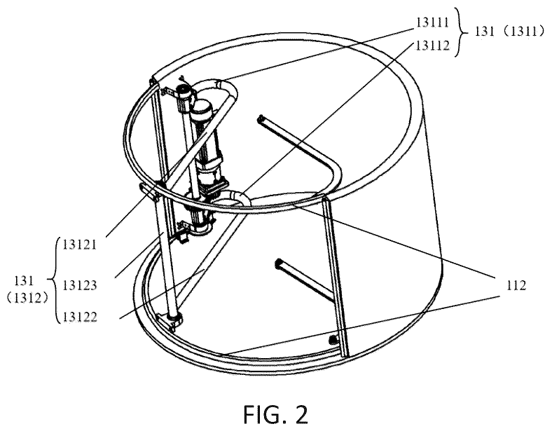

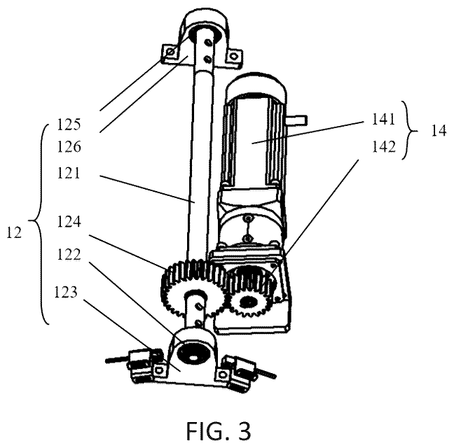

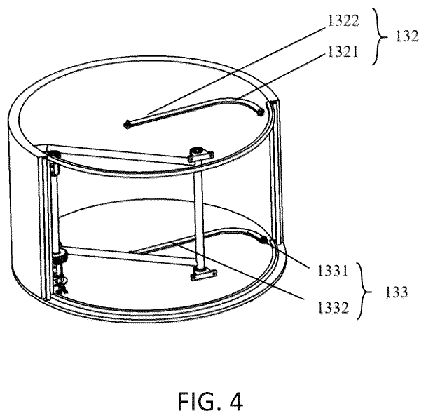

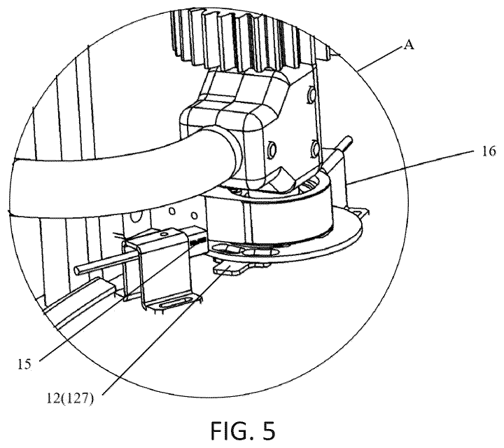

Below, the exemplary embodiments of the present application will be described in detail with reference to the accompanying drawings. Of course, the described embodiments are only a part of the embodiments of the present application and not all embodiments. It should be understood that the present application is not limited by the exemplary embodiments described herein. FIG. 1 is a schematic structural diagram of an automatic side-opening drone hangar provided by an exemplary embodiment of the present application. FIG. 2 is a schematic structural diagram of another automatic side-opening drone hangar provided by another exemplary embodiment of the present application. FIG. 3 is a schematic structural diagram of a transmission device and a driving device provided by an exemplary embodiment of the present application. FIG. 4 is a side view schematic diagram of the automatic side-opening drone hangar provided by an exemplary embodiment of the present application. FIG. 5 is an enlarged schematic diagram of area A in the automatic side-opening drone hangar provided by an exemplary embodiment of the present application. As shown in FIGS. 1-5, a drone automatic hangar comprises: a hangar body 11, a rotating assembly 12, a swing arm assembly 13, and a driving assembly 14. The hangar body 11 comprises a hangar door 111, the rotating assembly 12 is fixedly connected to an inner wall of the hangar body 11, and the swing arm assembly 13 comprises a first swing arm 131. A first end of the first swing arm 131 is fixedly connected to the hangar door 111, a second end of the first swing arm 131 is fixedly connected to the rotating assembly 12, and the driving assembly 14 is fixedly connected to the inner wall of the hangar body 11. The driving assembly 14 is transmission-connected with the rotating assembly 12. The driving assembly 14 is used for driving the rotating assembly 12 to cause the first swing arm 131 to rotate around an axis of the rotating assembly 12, so that the first swing arm 131 causes the hangar door 111 to rotate around an outer wall of the hangar body 11.

In an embodiment of the present application, in order to improve the convenience of opening the hangar door, the rotational force of the driving assembly 14 is transmitted to the rotating assembly 12, and the rotating assembly 12 transmits the rotational force to the swing arm assembly 13. Therefore, the swing arm assembly 13 causes the hangar door 111 to rotate around the outer wall of the hangar body 11. The swing arm assembly 13 may comprise a first swing arm 131. It should be understood that the rotational force is transmitted through the driving assembly 14 to the rotating assembly 12, and the rotating assembly 12 transmits the rotational force to the first swing arm 131. Therefore, the first swing arm 131 causes the hangar door 111 to rotate around the outer wall of the hangar body 11.

Specifically, the hangar body 11 is composed of a hangar frame and the hangar door 111. The hangar frame has a semi-open space, and by coordinating the hangar door 111 with the semi-open space of the hangar frame, a fully-enclosed space is formed. In other words, the hangar body 11 achieves switching between the semi-open space and the fully-enclosed space through the opening and closing of the hangar door 111.

Preferably, the hangar frame is composed of a first base plate, a second base plate, and a first curved component. The first base plate supports the bottom of the first curved component, and the second base plate is fixedly connected to the top of the first curved component. The first base plate, the second base plate, and the first curved component may be made of metal materials, metal oxide materials, glass, or some waterproof materials. The first base plate and the second base plate are circular. The hangar door 111 is composed of a second curved component. The second curved component may be made of metal materials, metal oxide materials, glass, or some waterproof materials. Since both the hangar frame and the hangar door 111 are both arc-shaped, when the hangar door 111 fits onto the hangar frame, a cylindrical body with an enclosed space can be formed.

Specifically, when the hangar door 111 opens, part of the swing arm assembly 13 is inside the hangar frame, while another part of the swing arm assembly 13 is outside the hangar frame. When the hangar door 111 closes, the swing arm assembly 13 is entirely located inside the hangar frame. Wherein, the swing arm assembly 13 comprises the first swing arm 131. It should be understood that when the hangar door 111 opens, part of the first swing arm 131 is inside the hangar frame, while the other part of the swing arm assembly 13 is outside the hangar frame. When the hangar door 111 closes, the first swing arm 131 is entirely located inside the hangar frame.

As shown in FIGS. 1-3, the rotating assembly 12 may comprise: a rotating shaft 121, a first bearing 122, a first bearing seat 123, and a transmission component 124. The first bearing 122 is sleeved on a first end of the rotating shaft 121, the first bearing seat 123 is fixedly connected to the bottom of the accommodating space of the hangar body 11, a second end of the first swing arm 131 is fixedly connected to the rotating shaft 121. The first bearing seat 123 is used for fixing the first bearing 122. The transmission component 124 is sleeved on the rotating shaft 121. The transmission component 124 is transmission-connected with the driving assembly 14. The driving assembly 14 is used for driving the transmission component 124 to cause the rotating shaft 121 to rotate along the axis of the first bearing 122.

In an embodiment of the present application, in order to improve the stability and smoothness of rotation of the first swing arm 131, the present application provides greater stability for the first swing arm 131 through the rotating shaft 121. The rotating shaft 121 causing the first swing arm 131 to rotate not only increases stability, but also increases smoothness.

Additionally, in the present application, an inner shaft of the first bearing 122 is fixedly connected to the rotating shaft 121, thereby limiting the rotation of the rotating shaft 121 within the area restricted by the inner shaft, which prevents the displacement of the rotating shaft 121 from increasing the difficulty of opening and closing the hangar door 111. Wherein, the first bearing 122 comprises an inner shaft and an outer shaft, with the outer wall of the inner shaft connected to the inner wall of the outer shaft by a roller. In other words, the inner shaft rotates around the central axis of the outer shaft through the roller.

Moreover, in order to further improve the overall stability of the first swing arm 131, the present application fixes the first bearing 122 through the first bearing seat 123, thereby ensuring the stability of rotation of the rotating shaft 121, and further improving the stability of rotation of the first swing arm 131. Wherein, the first bearing seat 123 comprises a fixing hole, the fixing hole fit with either the first bearing 122 or the outer wall of the first bearing 122, thereby improving the stability of the first bearing 122.

Wherein, the transmission component 124 may comprise a gear and be transmission-connected with the driving assembly 14 through the gear. The driving assembly 14 provides rotational driving force or action force to the gear, and the gear causes the rotating shaft 121 to rotate. The rotating shaft 121 causes the first bearing 122 to rotate, and the rotating shaft 121 causes the first swing arm 131 to rotate.

The automatic side-opening drone hangar and control method provided by the present application comprises: a hangar body, a rotating assembly, a swing arm assembly, and a driving assembly. The hangar body comprises a hangar door. The rotating assembly is fixedly connected to the inner wall of the hangar body. The swing arm assembly comprises a first swing arm. A first end of the first swing arm is fixedly connected to the hangar door. A second end of the first swing arm is fixedly connected to the rotating assembly. The driving assembly is fixedly connected to the inner wall of the hangar body. The driving assembly is transmission-connected with the rotating assembly. The driving assembly is used for driving the rotating assembly to cause the first swing arm to rotate around the axis of the rotating assembly, to cause the first swing arm to cause the hangar door to rotate around the outer wall of the hangar body. The driving assembly drives the rotating assembly to cause the first swing arm to rotate around the axis of the rotating assembly, therefore the first swing arm causes the hangar door to rotate around the outer wall of the hangar body to achieve opening and closing of the drone hangar. In addition, since the hangar door rotates around the outer wall of the hangar body, the space occupied by the hangar door is also reduced. The present application adopts a side-opening design, which can better protect electrical equipment inside the hangar, the drone, and other components. Additionally, by fixing the first swing arm on the transmission component and having the first swing arm rotate within a certain spatial area inside the hangar, the support for the hangar door is enhanced, and the stability of rotation of the hangar door is improved. Furthermore, when the drone takes off, the side-opening design will not obstruct the flight of the drone.

As shown in FIGS. 1-3, the rotating assembly 12 may comprise: a second bearing 125 and a second bearing seat 126. The second bearing 125 is sleeved on a second end of the rotating shaft 121, and the second bearing seat 126 is fixed on the inner wall of the hangar body 11. The second bearing seat 126 is used for fixing the second bearing 125.

In an embodiment of the present application, in order to further enhance the stability of rotation of the first swing arm 131, the second bearing seat 126 can be used for fixing the second bearing 125, and the second bearing 125 is sleeved on the second end of the rotating shaft 121, thereby ensuring the stability of the second end of the rotating shaft 121. The stability of the first end of the rotating shaft 121 is ensured by the first bearing 122 and the first bearing seat 123, and the stability of the second end of the rotating shaft 121 is ensured by the second bearing 125 and the second bearing seat 126, thereby ensuring the overall stability of the rotating shaft 121, and further improving the stability of rotation of the first swing arm 131.

Wherein, the second bearing seat 126 comprises a fixing hole, and the fixing hole matches the second bearing 125 or fits with the outer wall of the second bearing 125, thereby fixing the second bearing 125. The second bearing 125 comprises an inner shaft and an outer shaft. An outer wall of the inner shaft of the second bearing 125 is connected to the inner wall of the outer shaft through ball bearings, and the inner shaft of the second bearing 125 rotates around the central axis of the outer shaft through the ball bearings.

In addition, the accommodating space in the present application is the semi-open space formed by the hangar frame, and this accommodating space can store the drone and other components, which are not limited herein.

As shown in FIGS. 1-2, the first swing arm 131 comprises a first bent part 1311 and a first straight part 1312. One end of the first bent part 1311 is fixedly connected to one end of the first straight part 1312. Another end of the first bent part 1311 is fixedly connected to the rotating shaft 121. Another end of the first straight part 1312 is fixedly connected to the inner wall of the hangar door 111. The first bent part 1311 is used for limiting the rotation of the hangar door 111 around the outer wall of the hangar body 11.

In an embodiment of the present invention, in order for a part of the first swing arm 131 to adapt to the hangar frame when the hangar door 111 stops, the first swing arm 131 of the present application is configured as the first straight part 1312 and the first bent part 1311. The first bent part 1311 with a bent angle can adapt to the hangar frame, wherein, the bent angle can be 90 degrees. Thus, the outer wall of the first bent part 1311 can fit with one end of the first curved component.

Preferably, the first straight part 1312 of the first swing arm 131 may comprise a first straight rod 13121, a second straight rod 13122, and a third straight rod 13123. The first bent part 1311 may comprise a first bent rod 13111 and a second bent rod 13112. Wherein, the first straight rod 13121 is fixedly connected to the first bent rod 13111, the first bent rod 13111 is fixedly connected to the second end of the rotating shaft 121 through a first rotating component, and the first rotating component is fixed on the second end of the rotating shaft 121. The first straight rod 13121 is fixedly connected to the third straight rod 13123. A first end of the third straight rod 13123 is fixedly connected to the hangar door 111 through a first fixing component. The second bent rod 13112 is fixedly connected to the first end of the rotating shaft 121 through a second rotating component, and the second rotating component is fixed on the first end of the rotating shaft 121. The second bent rod 13112 is fixedly connected to the second straight rod 13122. The second straight rod 13122 is fixedly connected to the third straight rod 13123. A second end of the third straight rod 13123 is fixedly connected to the hangar door 111 through the second fixing component.

Optionally, the first fixing component may comprise a third bearing and a third bearing seat. The third bearing is sleeved on the first end of the third straight rod, and the third bearing seat fixes the third bearing. The third bearing seat is fixed on the hangar door 111. The third bearing seat comprises a fixing hole, and the fixing hole matches the third bearing or fits with an outer wall of an outer shaft of the third bearing. An inner shaft and outer shaft of the third bearing can be connected by ball bearings, and the inner shaft can rotate around the central axis of the outer shaft. Wherein, when the second end of the rotating shaft 121 rotates, its force is transmitted to the first rotating component. The first rotating component transmits the force to the first bent rod 13111. The first bent rod 13111 transmits the force to the first straight rod 13121. The first straight rod 13121 transmits the force to the first end of the third straight rod 13123. The third straight rod 13123 causes the inner shaft of the third bearing to rotate around its central axis.

Optionally, the second fixing component may comprise a fourth bearing and a fourth bearing seat. The fourth bearing is sleeved on the second end of the third straight rod, and the fourth bearing seat fixes the fourth bearing. The fourth bearing seat is fixed on the hangar door 111. The fourth bearing seat comprises a fixing hole, and the fixing hole matches the fourth bearing or fits with the outer wall of the outer periphery of the fourth bearing. The inner shaft and outer shaft of the fourth bearing can be connected by ball bearings, and the inner shaft can rotate around the central axis of the outer shaft. The second end of the third straight rod 13123 rotates around its own central axis. Wherein, when the first end of the rotating shaft 121 rotates, its force is transmitted to the second rotating component. The second rotating component transmits the force to the second bent rod 13112. The second bent rod 13112 transmits the force to the second straight rod 13122. The second straight rod 13122 transmits the force to the second end of the third straight rod 13123. The third straight rod 13123 causes the inner shaft of the fourth bearing to rotate around its central axis.

As shown in FIG. 4, the swing arm assembly comprises a second swing arm 132. A first end of the second swing arm 132 is movably connected to the top of the accommodating space of the hangar body 11. A third end of the second swing arm 132 is fixedly connected to the inner wall of the hangar door 111.

In an embodiment of the present application, in order to improve the overall rotational stability of the hangar door 111, the second swing arm 132 can provide support to other parts of the hangar door 111. Moreover, in order to allow the second swing arm 132 to rotate in sync with the first swing arm 131, the first end of the second swing arm 132 can be movably connected to the top of the accommodating space of the hangar body 11. Thus, the first end of the second swing arm 132 is movably connected to the bottom of the second base plate of the hangar body 11. Wherein, this movable connection can be achieved through a rotating shaft, thereby allowing the first end of the second swing arm 132 to rotate with the first swing arm 131.

As shown in FIG. 4, the second swing arm 132 comprises a second bent part 1321 and a second straight part 1322. A first end of the second bent part 1321 is fixedly connected to a first end of the second straight part 1322, and a second end of the second bent part 1321 is fixedly connected to the inner wall of the hangar door 111. A second end of the second straight part 1322 is movably connected to the top of the accommodating space of the hangar body 11; wherein, the second bent part 1321 is used for limiting the rotation of the hangar door around the outer wall of the hangar body.

In an embodiment of the present application, in order for a part of the second swing arm 132 to adapt to the hangar frame when the hangar door 111 stops, preventing damage to the hangar frame, the second swing arm 132 of the present application is configured as the second bent part 1321 and the second straight part 1322. The second bent part 1321 with a bent angle can adapt to the hangar frame. That is, the outer wall of the second bent part 1321 can fit with one end of the first curved component. Wherein, the bent angle can be 90 degrees.

Wherein, in the present application, the second end of the second straight part 1322 is movably connected to the top of the accommodating space of the hangar body 11. This movable connection can be a shaft connection, that is, the second bent part 1321 can be connected to the bottom of the second base plate through a rotating shaft. When the first swing arm 131 rotates, it can bring the second bent part 1321 to rotate around the rotating shaft.

Optionally, to further improve the overall stability of rotation of the hangar door 111, the swing arm assembly 13 may comprise a third swing arm 133. A first end of the third swing arm 133 is movably connected to the bottom of the accommodating space of the hangar body 11, that is, the first end of the third swing arm 133 is movably connected to the top of the first base plate of the hangar body 11. A second end of the third swing arm 133 is fixedly connected to the inner wall of the hangar door 111. Wherein, the movable connection may also be achieved through a rotating shaft, allowing the third swing arm 133 to rotate in sync with the first swing arm 131. The cooperation between the second swing arm 132 and the third swing arm 133 can better support the overall stability of rotation of the hangar door 111.

Optionally, the third swing arm 133 comprises a third bent part 1331 and a third straight part 1332. A first end of the third bent part 1331 is fixedly connected to a first end of the third straight part 1332, and a second end of the third bent part 1331 is fixedly connected to the inner wall of the hangar door 111. A second end of the third straight part 1332 is movably connected to the top of the accommodating space of the hangar body 11, wherein, the third bent part 1331 is used for limiting the rotation of the hangar door around the outer wall of the hangar body.

In an embodiment of the present application, in order for a part of the third swing arm 133 to adapt to the hangar frame when the hangar door 111 stops, preventing damage to the hangar frame, the third swing arm 133 of the present application is configured as the third bent part 1331 and the third straight part 1332. The third bent part 1331 with a bent angle can adapt to the hangar frame, that is, the outer wall of the third bent part 1331 can fit with one end of the first curved component. The bent angle can be 90 degrees.

Wherein, the second end of the third straight part 1332 in the present application is movably connected to the top of the accommodating space of the hangar body 11. This movable connection can be a shaft connection, that is, the third bent part 1331 can be connected to the bottom of the second base plate through a rotating shaft. When the first swing arm 131 rotates, it can bring the third bent part 1331 to rotate around the rotating shaft.

As shown in FIGS. 1-3, the driving assembly 14 comprises a motor 141 and a gear 142. The motor 141 is transmission-connected to the gear 142, and the gear 142 is transmission-connected to the transmission component 124.

In an embodiment of the present application, in order to drive the rotation of the rotating shaft 121, the motor 141 is transmission-connected to the gear 142. The motor 141 provides a driving force to the gear 142, and based on this driving force, the gear 142 transmits the generated force to the transmission component 124, and the transmission component 124 transmits the force to the rotating shaft 121, causing the rotating shaft 121 to rotate.

Wherein, when the transmission component 124 is a driving gear, the driving gear meshes with the gear 142, so that the gear 142 can transmit force to the driving gear. Additionally, the motor 141 of the present application can be transmission-connected to the gear 142 through a reducer, and the reducer is used for reducing the speed of the gear 142.

As shown in FIG. 1, the hangar body comprises a hangar frame, the hangar frame comprises a first base plate, a second base plate, and a first curved component. The top edge of the first base plate is fixedly connected to the bottom of the first curved component, and the bottom edge of the second base plate is fixedly connected to the top of the first curved component. The hangar frame and the hangar door match to form a cylinder or an elliptical cylinder.

As shown in FIGS. 1-5, the automatic side-opening drone hangar may further comprise a door-opening sensor 15 and a controller. The door-opening sensor 15 is communicatively coupled with the controller. The door-opening sensor 15 is fixed at the bottom of the accommodating space of the hangar body 11, and the controller is communicatively coupled with the driving assembly 14. The door-opening sensor 15 is used for sending a first trigger signal to the controller, and the controller is used for generating a first stop command to stop the operation of the driving assembly 14.

In an embodiment of the present application, to stop the hangar door 111 at a designated position after opening, the continued rotation of the hangar door 111 needs to be stopped. If the hangar door 111 continues to rotate, it will cause damage to the hangar body 11. Therefore, the present application configures the door-opening sensor 15. When the door-opening sensor 15 is triggered, it sends the first trigger signal to the controller, which generates the first stop command to stop the operation of the driving assembly 14.

Specifically, a disc is arranged below the first bearing seat 123. The disc is sleeved on the first end of the rotating shaft 121, and a contact plate 127 is fixedly connected to the edge of the bottom of the disc. The contact plate 127 can trigger the door-opening sensor 15 and send the first trigger signal to the controller. The controller generates the first stop command to stop the operation of the driving assembly 14, at which point the hangar door 111 is fully opened.

Wherein, the first disc with the contact plate 127 rotates in sync with the rotating shaft 121. When the contact plate 127 rotates close to the door-opening sensor 15, it can cut an electromagnetic field generated by the door-opening sensor 15, at which point the door-opening sensor 15 is triggered and generates the first trigger signal.

As shown in FIGS. 1-5, the automatic side-opening drone hangar may further comprise a door-closing sensor 16 and a controller. The door-closing sensor 16 is communicatively connected with the controller. The door-closing sensor 16 is fixed at the bottom of the accommodating space of the hangar body 11, and the controller is communicatively connected with the driving assembly 14. The door-closing sensor 16 is used for sending a second trigger signal to the controller, and the controller is used for generating a second stop command to stop the operation of the driving assembly 14.

In an embodiment of the present application, to stop the hangar door 111 at a designated position after closing, the continued rotation of the hangar door 111 needs to be stopped. If the hangar door 111 continues to rotate, it will cause damage to the hangar body 11. Therefore, the present application configures the door-closing sensor 16. When the door-closing sensor 16 is triggered, it sends the second trigger signal to the controller, and the controller generates the second stop command to stop the operation of the driving assembly 14.

Specifically, when the hangar door 111 is closed, the contact plate 127 rotates in sync with the disc. When the contact plate 127 triggers the door-opening sensor 15, the door-closing sensor 16 sends the generated second trigger signal to the controller, and the controller generates the second stop command to stop the operation of the driving assembly 14, at which point the hangar door 111 is fully closed.

Wherein, when the contact plate 127 rotates close to the door-closing sensor 16, it can cut an electromagnetic field generated by the door-closing sensor 16, at which point the door-closing sensor 16 is triggered and generates the second trigger signal.

As shown in FIGS. 1-2, the hangar body 11 comprises a door frame that matches the hangar door 111. The edge of the door frame is fixedly connected with a sealing strip 112, wherein, the door frame is formed by the edge of the hangar frame, which forms the semi-open space.

In an embodiment of the present application, the sealing strip 112 is laid along the edge of the door frame. During the closing process of the hangar door 111, the hangar door 111 first fits with and compresses the sealing strip 112, and when the closing stops, the sealing strip 112 is compressed into place and fully fits with the hangar door 111, creating a more private sealed space for the hangar body 11. Wherein, the door frame is formed by the edge of the first base plate, the edge of the second base plate, and the edge of the first curved component.

The present application provides a control method for an automatic side-opening drone hangar, applicable to any of the automatic side-opening drone hangars described above. The control method comprises: receiving an opening command; wherein, the opening command is a command to open the hangar door; executing the opening command and controlling the driving assembly to drive the rotating assembly to cause the first swing arm to rotate around the axis of the rotating assembly, to cause the first swing arm to cause the hangar door to rotate around the outer wall of the hangar body; and stopping the operation of the driving assembly when the hangar door reaches a target position.

In an embodiment of the present application, when the hangar door 111 opens to the target position, the contact plate 127 cuts the electromagnetic field of the door-opening sensor 15, thereby triggering the door-opening sensor 15 and generating the first trigger signal to the controller. The controller generates the first stop command based on this trigger signal to stop the operation of the driving assembly. When the hangar door 111 closes to the target position, the contact plate 127 cuts the electromagnetic field of the door-closing sensor 16, thereby triggering the door-closing sensor 16 and generating the second trigger signal to the controller. The controller generates the second stop command based on this second trigger signal to stop the operation of the driving assembly.

The present application provides a control system for the automatic side-opening drone hangar, comprising: a receiving module, used for receiving an opening command; wherein the opening command is a command to open the hangar door; an execution module, used for executing the opening command and controlling the driving assembly to drive the rotating assembly to cause the first swing arm to rotate around the axis of the rotating assembly, to cause the first swing arm to cause the hangar door to rotate around the outer wall of the hangar body; and a stopping module, used for stopping the operation of the driving assembly when the hangar door reaches the target position.

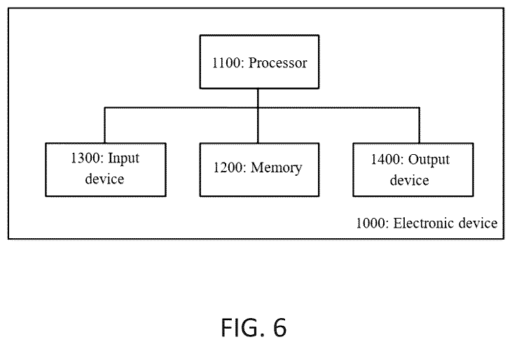

FIG. 6 illustrates a block diagram of the electronic device according to an embodiment of the present application.

As shown in FIG. 6, an electronic device 1000 comprises one or more processors 1100 and a memory 1200.

The processor 1100 may be a central processing unit (CPU) or another form of processing unit with data processing capabilities and/or instruction execution capabilities, and may control other components within the electronic device 1000 to perform desired functions.

The memory 1200 may comprise one or more computer program products, which may comprise various forms of computer-readable storage media, such as volatile memory and/or non-volatile memory. The volatile memory may comprise, for example, random access memory (RAM) and/or cache memory. The non-volatile memory may comprise, for example, read-only memory (ROM), hard drives, flash memory, etc. One or more computer program instructions may be stored on the computer-readable storage medium, and the processor 1100 may run the program instructions to implement the control method for the automatic side-opening drone hangar as described in the various embodiments of the present application and/or other desired functions. The computer-readable storage medium may also store various contents, such as input signals, signal components, noise components, etc.

In one embodiment, the electronic device 1000 may further comprise: an input device 1300 and an output device 1400, which are interconnected through a bus system and/or other forms of connection mechanisms (not shown).

When the electronic device 1000 is a standalone device, the input device 1300 may be a communication network connector used for receiving input signals collected from a first device and a second device.

Additionally, the input device 1300 may also comprise, for example, a keyboard, mouse, etc.

The output device 1400 may output various information externally, including determined distance information, direction information, etc. The output device 1400 may comprise, for example, a display, speakers, printers, as well as communication networks and the remote output devices connected to them.

Of course, for simplification, FIG. 6 only shows some of the components related to the present application in the electronic device 1000, omitting components such as the bus, input/output interfaces, etc. In addition, based on specific application situations, the electronic device 1000 may further comprise any other appropriate components.

The computer program products may be written in any combination of one or more programming languages used to perform the operations of the embodiments of the present application, including object-oriented programming languages such as Java, C++, etc., and conventional procedural programming languages such as the “C” language or similar programming languages. The program code may be executed entirely on the user computing device, partially on the user device, as a standalone software package, partially on the user computing device and partially on a remote computing device, or entirely on a remote computing device or server.

The computer-readable storage medium can take the form of any suitable combination of one or more readable media. Readable media can be readable signal media or readable storage media. Readable storage media may comprise, but are not limited to, electrical, magnetic, optical, electromagnetic, infrared, or semiconductor systems, devices, or apparatuses, or any suitable combination of the above. More specific examples (a non-exhaustive list) of readable storage media include: electrical connections having one or more wires, portable disks, hard disks, random access memory (RAM), read-only memory (ROM), erasable programmable read-only memory (EPROM or flash memory), optical fibers, portable compact disc read-only memory (CD-ROM), optical storage devices, magnetic storage devices, or any suitable combination of the above.

For illustration and description purposes, the above descriptions have been provided. Moreover, these descriptions are not intended to limit the embodiments of the present application to the forms disclosed herein. Although multiple example aspects and embodiments have been discussed above, those skilled in the art will recognize that certain variations, modifications, alterations, additions, and sub-combinations are possible.

1. An automatic side-opening drone hangar, characterized in that, it comprises:
a hangar body, the hangar body comprising a hangar door;
a rotating assembly, the rotating assembly fixedly connected to an inner wall of the hangar body;
a swing arm assembly, the swing arm assembly comprising a first swing arm, a first end of the first swing arm fixedly connected to the hangar door, and a second end of the first swing arm fixedly connected to the rotating assembly;
a driving assembly, the driving assembly fixedly connected to the inner wall of the hangar body, and the driving assembly transmission-connected to the rotating assembly; the driving assembly is used for driving the rotating assembly to cause the first swing arm to rotate around an axis of the rotating assembly, to cause the first swing arm to cause the hangar door to rotate around an outer wall of the hangar body.

2. The automatic side-opening drone hangar according to claim 1, characterized in that, the rotating assembly comprises: a rotating shaft, a first bearing, a first bearing seat, and a transmission component; the first bearing is sleeved on a first end of the rotating shaft, the first bearing seat is fixedly connected to the bottom of an accommodating space of the hangar body, a second end of the first swing arm is fixedly connected to the rotating shaft, the first bearing seat is used for fixing the first bearing, the transmission component is sleeved on the rotating shaft, the transmission component is transmission-connected to the driving assembly, and the driving assembly is used for driving the transmission component to cause the rotating shaft to rotate around an axis of the first bearing.

3. The automatic side-opening drone hangar according to claim 2, characterized in that, the rotating assembly comprises: a second bearing and a second bearing seat; the second bearing is sleeved on a second end of the rotating shaft, the second bearing seat is fixed on the inner wall of the hangar body, and the second bearing seat is used for fixing the second bearing.

4. The automatic side-opening drone hangar according to claim 2, characterized in that, the first swing arm comprises: a first bent part and a first straight part; one end of the first bent part is fixedly connected to one end of the first straight part, another end of the first bent part is fixedly connected to the rotating shaft, another end of the first straight part is fixedly connected to the inner wall of the hangar door, and the first bent part is used for limiting the rotation of the hangar door around the outer wall of the hangar body.

5. The automatic side-opening drone hangar according to claim 4, characterized in that, the swing arm assembly comprises a second swing arm; a first end of the second swing arm is movably connected to the top of the accommodating space of the hangar body, and a second end of the second swing arm is fixedly connected to the inner wall of the hangar door.

6. The automatic side-opening drone hangar according to claim 5, characterized in that, the second swing arm comprises a second bent part and a second straight part; a first end of the second bent part is fixedly connected to a first end of the second straight part, a second end of the second bent part is fixedly connected to the inner wall of the hangar door, and a second end of the second straight part is movably connected to the top of the accommodating space of the hangar body; wherein, the second bent part is used for limiting the rotation of the hangar door around the outer wall of the hangar body.

7. The automatic side-opening drone hangar according to claim 2, characterized in that, the hangar body comprises a hangar frame; the hangar frame comprises a first base plate, a second base plate, and a first curved component; the top edge of the first base plate is fixedly connected to the bottom of the first curved component, a bottom edge of the second base plate is fixedly connected to the top of the first curved component, and the hangar frame and the hangar door form a cylinder or an elliptical cylinder.

8. The automatic side-opening drone hangar according to claim 1, characterized in that, it further comprises a door-opening sensor and a controller; the door-opening sensor is communicatively connected to the controller, the door-opening sensor is fixed at the bottom of the accommodating space of the hangar body, the controller is communicatively connected to the driving assembly, the door-opening sensor is used for sending a first trigger signal to the controller, and the first controller is used for generating a first stop command to stop the operation of the driving assembly.

9. The automatic side-opening drone hangar according to claim 7, characterized in that, the hangar body comprises a door frame matching the hangar door; the edge of the door frame is fixedly connected to a sealing strip; wherein, the door frame is formed by the edge of the hangar frame that forms a semi-open space.

10. A control method for an automatic side-opening drone hangar, characterized in that, it is adapted to the automatic side-opening drone hangar described in claim 1, the control method comprising:
receiving an opening command; wherein, the opening command is a command to open the hangar door;
executing the opening command and controlling the driving assembly to drive the rotating assembly to cause the first swing arm to rotate around the axis of the rotating assembly, to cause the first swing arm to cause the hangar door to rotate around the outer wall of the hangar body;
stopping the operation of the driving assembly when the hangar door reaches a target position.
